(19) United States
(12) Patent Application Publication
(10) Pub. No.: US 2016/0042344 A1
(43) Pub. Date: Feb. 11, 2016

(54) METHOD AND SYSTEM FOR FACILITATING ONLINE AND OFFLINE FINANCIAL TRANSACTIONS

(71) Applicants: Ramesh THIMMANA, (US); Naveen PATIBANDLA, (US)

(72) Inventors: Ramesh THIMMANA, Hyderabad (IN); Naveen PATIBANDIA, HYDERABAD (IN)

(73) Assignees: Naveen Patibandla, Hyderabad, TS (IN); Ramesh Thimmana, HYDERABAD, TS (IN)

(21) Appl. No.: 14/366,267

(22) PCT Filed: Nov. 13, 2013
(86) PCT No.: PCT/IB2013/060099

§ 371 Date: Jun. 18, 2014

(30) Foreign Application Priority Data
Apr. 23, 2013 (IN) 1776/CHE/2013

(51) Int. Cl. G06Q 20/36; G06Q 20/38

(52) U.S. Cl. CPC G06Q 20/36; G06Q 20/3821

(57) ABSTRACT

Exemplary embodiments of the present disclosure are directed towards a system and method for facilitating online and offline financial transactions using the digital wallets. The method includes receiving a request of a user by a wallet service providing platform for creating a primary digital wallet, determining the authenticity of the credentials provided by the user for associating the financial account of the user with the primary digital wallet, transmitting a message to the data communication device to activate the primary digital wallet and for successful association of the base financial account. The method further includes allowing the user to top-up the primary digital wallet with a predetermined amount by transferring a balance available in the source financial account and to create one or more secondary digital wallets linked to the primary digital wallet to be used by the user specified affiliates.

### TECHNICAL FIELD

The present disclosure relates to the field of financial transaction systems and methods. More particularly the present disclosure relates to a computer implemented method and system for facilitating online and offline financial transactions over a network using the digital wallets.

### BACKGROUND

In traditional payment systems, a person intending to pay for a purchased item has to rely on payment options such as currency, cheques, credit cards, or debit cards. Unfortunately, these types of payment instruments have many limitations in terms of accessibility to general populace and security issues. Moreover, the cheques used for the exchange of goods and service can be of fraud and can cause an extensive loss to financial institutions.

With the advent, of E-Commerce/M-Commerce the payment instruments like credit cards, debit cards, charge cards, pre-paid cards became popular. All these payment methods alleviated the problem typically associated with cash like printing, distributing, handling, risks of counterfeit, theft and the like. With rapid paces in technology along with reduced costs of internet access and computer/mobile penetration, ensured the increasing popularity of the payment methods and enabled digital transactions even without the physical exchange of cash between buyer and seller. But when a credit card is stolen, it may be used online or at a Point of Sale (POS) terminal by anyone wanting to commit fraud.

There are number of other services which are enabled by banks like Internet-Banking, Mobile-Banking and Non Banking players introducing electronic wallet services, wherein money can be held in the account which can be used for online purchases and also receive money into the account. Payment gateway providers enable payments by processing E-Commerce/M-Commerce transactions on top of either a Credit/Debit Card or Digital wallet or Internet banking.

The presumptions in all the above solutions are that there would be a bank account and a card with the buyer. Typically, in emerging economies there is a significant amount of population without access to bank account or banking facilities and in many a case banks do not extend facilities of internet banking, Debit Card, Cheque book facility due to the costs involved in maintaining such bank accounts. Moreover, significant number of families will only have one account who is typically the earning member of the family. Other members of the family, spouse and children will not have a bank account. They need to either depend on cash or a prepaid gift card for offline or online purchasing of goods and services.

Moreover, each digital transaction or a point of sale (POS) transaction typically is fulfilled by number of parties in between processing the transaction which increases the cost of each transaction. This may also result in non fulfilment of the transaction if one of the systems in the payment chain fails. Also the existing wallet solutions transfer the money from a bank to a correspondent bank, possibly offshore. These results in float money taken out of domestic banking system, and offshore money and wallets might be subjected to regulatory issues.

In the light of aforementioned discussion there exists a need of a common shared platform which provides digital wallet services with common interfaces providing an open access for multiple partner banks, merchants and users that may be used for online and offline financial transitions.

### BRIEF SUMMARY

Exemplary embodiments of the present disclosure are directed towards a system and method for facilitating online and offline financial transactions.

An exemplary objective of the present disclosure is to provide and integrate the digital wallet users, merchants and the financial intermediaries to a common platform.

An exemplary objective of the present disclosure is to enable the users to associate the digital wallets to a source financial account.

Another exemplary objective of the present disclosure is to enable the users to create secondary digital wallets associated with the primary digital wallet to be used by the user specified affiliates.

Another exemplary objective of the present disclosure is to top up the digital wallets using the balance available in the source financial account.

Another exemplary objective of the present disclosure is to enable the users to use the digital wallets for offline transactions and online transactions.

Another exemplary objective of the present disclosure is to enable the users to restrict the usage of the digital wallets based on the location, merchant, product or service, number of transactions, total amount of transaction per day and the like.

Another exemplary objective of the present disclosure is to enable the users to associate an electronic digital card with the digital wallets for making offline transactions.

Still another exemplary objective of the present disclosure is to enable the users to use and restrict the usage of the digital wallets with/without using a Transaction Personal Identification Number.

Still another exemplary objective of the present disclosure is to enable the users to restrict the usage of the digital wallets for a certain number and merchants for unauthorized transactions.

Still another exemplary objective of the present disclosure is to use the authenticated communication details verified by the financial intermediaries for enabling the users to create and use the digital wallets. This enables to deliver the goods purchased online through the digital wallet users to an authenticated correspondence address.

Still another exemplary objective of the present disclosure is to enable the digital wallet users to rate the merchants.

Still another exemplary objective of the present disclosure is to track the transaction history of the digital wallets and transaction properties of a particular transaction.

According to a first aspect, the method includes receiving a request of a user by a wallet service providing platform for creating a primary digital wallet. The user prompted by an interface to enter credentials corresponding to a source financial account and a contact number of a data communication device associated with the source financial account to create an unique wallet identification code.

According to the first aspect, the method includes determining the authenticity of the credentials provided by the user for associating the financial account of the user with the primary digital wallet. The wallet service providing platform transmits a message to the data communication device to activate the primary digital wallet and for successful association of the base financial account.

According to the first aspect, the method includes allowing the user to top-up the primary digital wallet with a predetermined amount by transferring an amount available in the source financial account. The user enabled to select the primary digital wallet as a payment option for one or more online and offline financial transactions.

According to the first aspect, the method includes enabling the user to create one or more secondary digital wallets linked to the primary digital wallet for user specified affiliates. The secondary digital wallets credited with a predetermined amount using an amount available in the primary digital wallet for enabling the one or more user specified affiliates to use the one or more secondary digital wallets as the payment option for the one or more online and offline financial transactions.

According to a second aspect, the method includes receiving a request of a user by a base financial intermediary platform for creating a primary digital wallet and associating a source financial account with the primary digital wallet. The base financial intermediary platform registers the user request by confirming a contact number of a data communication device of the user and personal credentials associated with the source financial account.

According to the second aspect, the method includes transmitting the user request to a wallet service providing platform from a base financial intermediary platform to create the primary digital wallet. The wallet service providing platform processes the user request by providing a unique wallet identification code and transmits a message to the data communication device to activate the primary digital wallet and for successful association of the source financial account with the created primary digital wallet.

According to a third aspect, the method includes accumulating a total balance available in a primary digital wallets and secondary digital wallets to an escrow financial account associated with a base financial intermediary.

According to the third aspect, the method includes transferring a gross amount corresponding to online transactions and one or more offline transactions made by digital wallet users from the escrow account to a financial account of the wallet service providing platform of a base financial intermediary.

According to the third aspect, the method includes calculating a net payment to be made for one more online merchants and one or more offline merchants attached to the base financial intermediary.

According to the third aspect, the method includes adjusting an amount by transferring from positive net balance financial accounts of wallet service providing platform to negative net balance financial accounts of the wallet service providing platform.

According to the third aspect, the method includes clearing and transferring amount from the financial account of the wallet service providing platform to one or more online merchant accounts and one or more offline merchant accounts, which are due.

According to a fourth aspect, the system includes a wallet service providing platform for enabling the user to select as a payment option and make payments for online and offline financial transactions. The wallet service providing platform includes a transaction database for managing and storing a payment and purchase history of a primary digital wallet and secondary digital wallets. The wallet service providing platform further includes a controller and profile management database configured to maintain profile of users holding a primary digital wallet and control the usage of the primary digital wallet and secondary digital wallets associated with a unique identification code of the primary digital wallet.

According to the fourth aspect, the system includes base financial intermediary platforms for receiving a user request from the wallet service providing platform and transmitting the user request to the wallet service providing platform for associating a financial account of the user to the primary digital wallet and also allow the user to perform multiple financial transactions from the base financial account to the primary digital wallet and to the one or more secondary digital wallets. The user is enabled to transfer a balance available in the base financial account to the primary digital wallet and to the secondary digital wallets for making online payments and offline payments.

According to the fourth aspect, the system includes merchant terminals operated in a data communication network and in communication with the wallet service providing platform configured to read an electronic card associated to the primary digital wallet for receiving offline payments. The user enabled to select the wallet service providing platform for making online payment using the primary digital wallet.

According to a fifth aspect, the method includes generating a transaction code with generation date and expiry date for enabling the user to use the generated transaction code and the electronic card associated with the transaction code for tracking the validity and status of transactions online or offline.

According to the fifth aspect, the method includes transmitting transaction code to a data communication device of the user and dynamically associating the generated transaction code to an electronic card.

According to the fifth aspect, the method includes assigning a purchased state to the generated code. The method further includes changing the state of the generated code to a validated state on accessing the purchased online or offline goods/services and to an expired state on complete utility of the purchased online and offline goods/services or due to time limitations of the generated code.

### BRIEF DESCRIPTION OF DRAWINGS

Other objects and advantages of the present disclosure will become apparent to those skilled in the art upon reading the following detailed description of the preferred embodiments, in conjunction with the accompanying drawings, wherein like reference numerals have been used to designate like elements, and wherein:

FIG. 1 is a block diagram illustrating a networked system for providing digital wallet service to enable online and offline financial transactions.

FIG. 2 is a diagram illustrating a wallet service providing platform.

FIG. 3 is a diagram illustrating association of the primary digital wallets and the secondary digital wallets with the source financial account and the base financial intermediary.

FIG. 4 is a diagram illustrating transaction flows between the digital wallets and the merchant accounts through the escrow account.

FIG. 5 is a flow diagram illustrating a method for creating digital wallets which facilitates the user to perform the online and offline transactions using the digital wallets.

FIG. 6 is a flow diagram illustrating a method for creating a primary digital wallet through a base financial intermediary.

FIG. 7 is a flow diagram illustrating a method for creating primary digital wallet through a wallet service providing platform.

FIG. 8 is a flow diagram illustrating a method of creating secondary digital wallets.

FIG. 9 is a flow diagram illustrating a method to top-up the primary digital wallet.

FIG. 10 is a flow diagram illustrating a method to empty the primary digital wallet.

FIG. 11 is a flow diagram illustrating a method of making payments for online transactions using the primary or secondary digital wallets.

FIG. 12 is a flow diagram illustrating a method of making payments for offline transactions using the primary or secondary digital wallets.

FIG. 13 is a flow diagram illustrating a method of cancelling the primary digital and the secondary digital wallet.

FIG. 14 is a flow diagram illustrating a method of merchant registration process.

FIG. 15 is a flow diagram illustrating a method of netting and clearance process corresponding to transactions.

FIG. 16 is a flow diagram illustrating a method of tracking transaction properties of transactions performed using digital wallet platform.

### DETAILED DESCRIPTION

It is to be understood that the present disclosure is not limited in its application to the details of construction and the arrangement of components set forth in the following description or illustrated in the drawings. The present disclosure is capable of other embodiments and of being practised or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item.

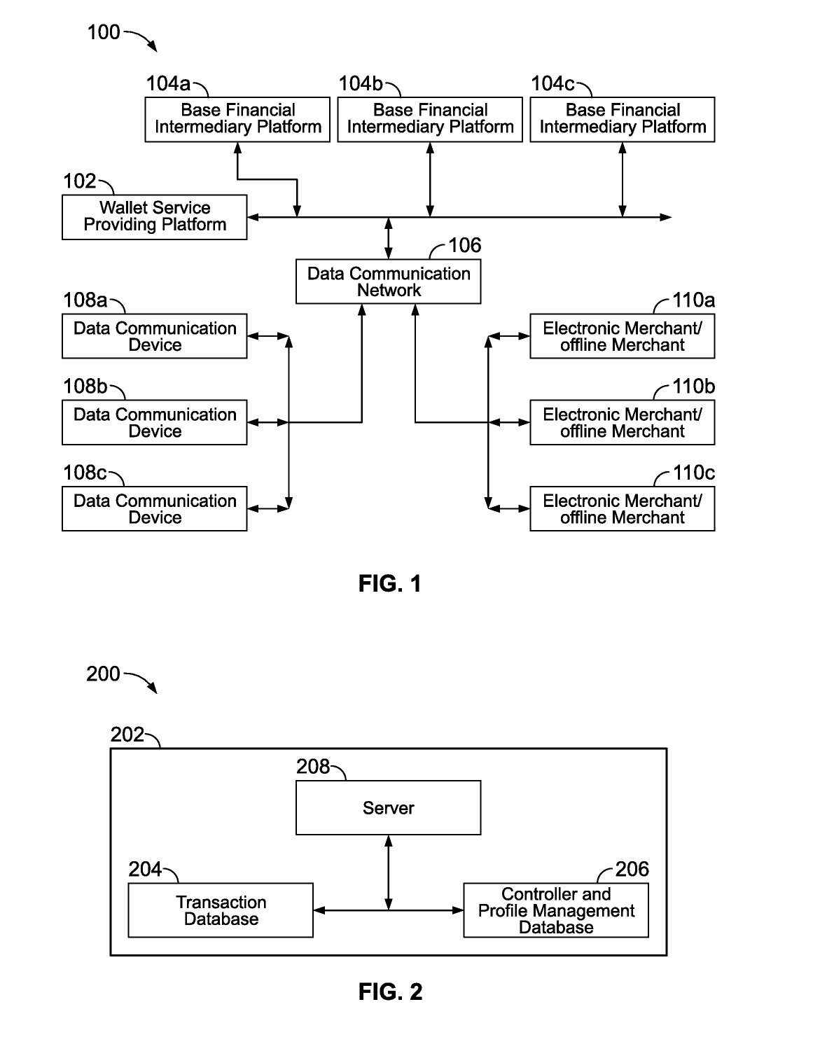

Referring to FIG. 1 is a block diagram 100 illustrating a networked system for providing digital wallet service to enable online and offline financial transactions. The networked system 100 comprising a wallet service providing platform 102, a user data communication device 108a, 108b and 108c herein after referred to as DCD which may include but not limited to a handheld device, a mobile phone, a laptop, a tablet and the like with unique contact number connected through a data communication network 106. The wallet service providing platform 102 may be used by the users to select as a payment option and make payments for the online and offline financial transactions. The user makes a request over the wallet service providing platform 102 to create a primary digital wallet. The user request for a wallet service may also be transferred from the base financial intermediary platforms 104a, 104b and 104c to the wallet service providing platform 102.

In accordance with a non limiting exemplary embodiment of the present disclosure, the wallet, service providing platform 102 receives a request from a user by prompting an interface to enter credentials corresponding to a base financial account and a contact number of the DCD associated with the base financial account to create a unique wallet identification code herein after referred as WID. The authenticity of the credentials provided by the user is determined for associating the financial account of the user with the primary digital wallet. Further, the wallet service providing platform 102 may also receive a request of the user through the base financial intermediary for creating the primary digital wallet and to associate the source financial account with the primary digital wallet. The corresponding base financial intermediary platform among the multiple base financial intermediary platforms 104a, 104b and 104c operating the source financial account registers the user request by confirming the contact number of the DCD of the user and the personal credentials associated with the source financial account.

According to a non limiting exemplary embodiment of the present disclosure, the received user request is transmitted to the wallet service providing platform 102 from the corresponding base financial intermediary platform. The wallet service providing platform 102 generates a unique WID. The generated unique WID is transmitted as a message to the DCD of the user to activate the primary digital wallet and for successful association of the source financial account with the created primary digital wallet.

As shown in FIG. 1, the wallet service providing platform 102 on creating a primary digital wallet allows the user to top-up the wallet with a required amount by transferring that amount from the balance available in the source financial account. Then the user is enabled to use the primary digital wallet as a payment option for the online and offline financial transactions. The wallet service providing platform 102 enables the user to create multiple secondary digital wallets linked to the primary digital wallet to be used by the user specified affiliates. The secondary digital wallets can be credited with a desired amount by utilizing the balance available in the primary digital wallet. The wallet service providing platform 102 further includes a transaction database for managing and storing a payment and purchase history of the primary digital wallets and the secondary digital wallets. It also includes a controller and profile management database to maintain profile of the users holding a digital wallet (both primary and secondary) and also to control the usage of the digital wallets and to further maintain the preferences of payment operations for the wallet users.

According to a non limiting exemplary embodiment of the present disclosure, the user of primary digital wallet is enabled to define the transaction limit for secondary digital wallets linked to the primary digital wallet and also to transfer the desired amount from the primary digital wallets to the secondary digital wallets. The usage of the secondary digital wallets can be controlled by restricting the usage of wallet at certain merchant establishments and certain physical locations for offline transactions, or in other words forbidding the usage of the secondary digital wallet with certain merchants although they accept the digital wallets for payments. For example the usage of the secondary digital wallets may be restricted based on products, merchants, and locations.

In accordance with a non limiting exemplary embodiment of the present disclosure, the total balance available in the multiple primary digital wallets and the secondary digital wallets linked to financial accounts of a particular base financial intermediary is accumulated to an escrow financial account at the same base financial intermediary. The payments made by the users using the multiple primary digital wallets and the secondary digital wallets is grossed and transferred from the escrow financial account to the financial account of the wallet service providing platform.

Further, FIG. 1 illustrating the networked system 100 includes a digital merchant electronic website enabling ECommerce/MCommerce or electronic merchant terminals/offline merchant terminals associated for offline transactions, 110a, 110b and 110c operated in the data communication network 106 and enable the multiple merchants to register with the wallet service providing platform 102. The registered merchant is provided with a unique merchant account for receiving the payments made by the users using the primary digital wallets and the secondary digital wallets. The electronic merchant terminals 110a, 110b and 110c are enabled to read an electronic card of the user associated with the primary digital wallet for receiving the offline payments corresponding to the offline purchases made by the user with that merchant. The merchant terminal will be able to read the electronic card by a card reading device and by downloading and integrating a specific application from wallet service providing platform to either the POS machine or the smart phone/DCD of the merchant. The user is enabled to rate the merchant for every purchase by entering the details which may include but not limited to processed period of transaction, merchant identification, product name and description and the like.

In accordance with a non limiting exemplary embodiment of the present disclosure, the user is enabled to dissociate the primary digital wallet with the source financial account. The user may also deactivate the secondary digital wallets and also transfer the balance available in the secondary digital wallets to the primary digital wallet. Further, upon the request of the user the primary digital wallet can be emptied by transferring the amount to the source financial account.

According to non limiting exemplary aspect of the present disclosure, the user of the digital wallets is allowed to define maximum number of transactions, amount spent using the digital wallet on per day basis, per merchant basis, and per location basis. Furthermore, the primary digital wallet user may also define a threshold value for the secondary digital wallets and prohibit the usage of the secondary digital wallets for the blocked merchants and products. The user can access and sign into the web application of the wallet service providing platform 102 and enter credentials associated with the electronic card to link it with the digital wallet. The electronic card may include but not limited to a Radio Frequency identification card and the like. The user can choose to make the offline transactions at the merchant terminals without entering the Transaction Personal Identification Number herein after referred to as TPIN for a limited number of transactions and for a limited amount as prior specified by the user. For example, these transactions may be helpful for a user in buying daily travel tickets. The electronic card can be used to auto charge the transaction amount for receiving the payment from the wallet service providing platform 102 for the ticket purchased by the user upon displaying the electronic card to the card reading POS machine.

In accordance with non limiting exemplary aspect of the present disclosure, the wallet service providing platform 102 is capable of maintaining and tracking transaction properties. The transaction properties refer to the capability of, after successful payment for a good or service of the platform to self generate a voucher identification code/transaction code which can be used for accessing the good or service. The voucher identification code can be utilized only for single or multiple usages within a limited period of time after which it would expire. The usage of voucher identification code for the consumption and validation will be tracked by the wallet service providing platform 102. This kind of application can be useful for one time view access of media files and also the electronic card can be used in lieu of a physical voucher at merchant establishments to access good or service upon pre payment. The access to good or service can be limited for one time usage, by place/location and time as well. This functionality is useful while validating and consumption of travel tickets, pay per view videos and like.

According to non limiting exemplary aspect of the present disclosure, the merchant terminals which may include but not limited to point of sale terminals configured to receive the payment for the offline purchases made by the users using the primary and/or secondary digital wallets. The merchant terminals 110a, 110b and 110c configured with the wallet service providing application enabled to read the details of the electronic card of the user. The merchant terminals 110a, 110b and 110c on reading the card retrieve the partial contact number of the DCD of the user and displays over the user interface, for cross checking with the wallet user to verify that the user is genuine holder of the card. The user can enter the TPIN to authenticate the payment. On successful authentication of the contact number and confirming the purchase details by the user, the payment terminal transmits the payment details from the terminal to the wallet platform for approval and fulfilment of the transaction.

Referring to FIG. 2 is a diagram 200 illustrating a wallet service providing platform. The wallet service providing platform 202 includes a transaction database 204 and a controller and profile management database 206 in communication with a server 208.

In accordance with a non limiting exemplary embodiment of the present disclosure, the wallet service providing platform 202 communicates with the DCD of a user through a data communication network to generate a unique wallet identification code (WID) for creating a primary digital wallet. The electronic merchant terminals corresponding to merchants are also in communication with the wallet service providing platform 202 to receive the payments of the users from the primary digital wallets and the secondary digital wallets. The user is enabled to select the digital wallet as a payment option for the online and offline financial transactions. The wallet service providing platform 202 also enables the user to create the secondary digital wallets linked to the primary digital wallet. The wallet service providing platform 202 provides a proprietary widget which can be configured over the website of the merchant, through which transactions can be enabled for online payments. For receiving offline payments a payment application may be downloaded to the POS device or to smart phone/DCD of the merchant for reading the electronic card of the user to receive the payments.

According to a non limiting exemplary embodiment of the present disclosure, the wallet service providing platform 202 includes a transaction database 204 for managing and storing the payments made by the users for the online and offline financial transactions using the primary and secondary digital wallets, purchase history of the primary digital wallet and the secondary digital wallets. The platform 202 also includes a controller and profile management database 206 to maintain the profile of the users holding the primary digital wallet and control the usage of the primary digital wallet and the associated secondary digital wallets.

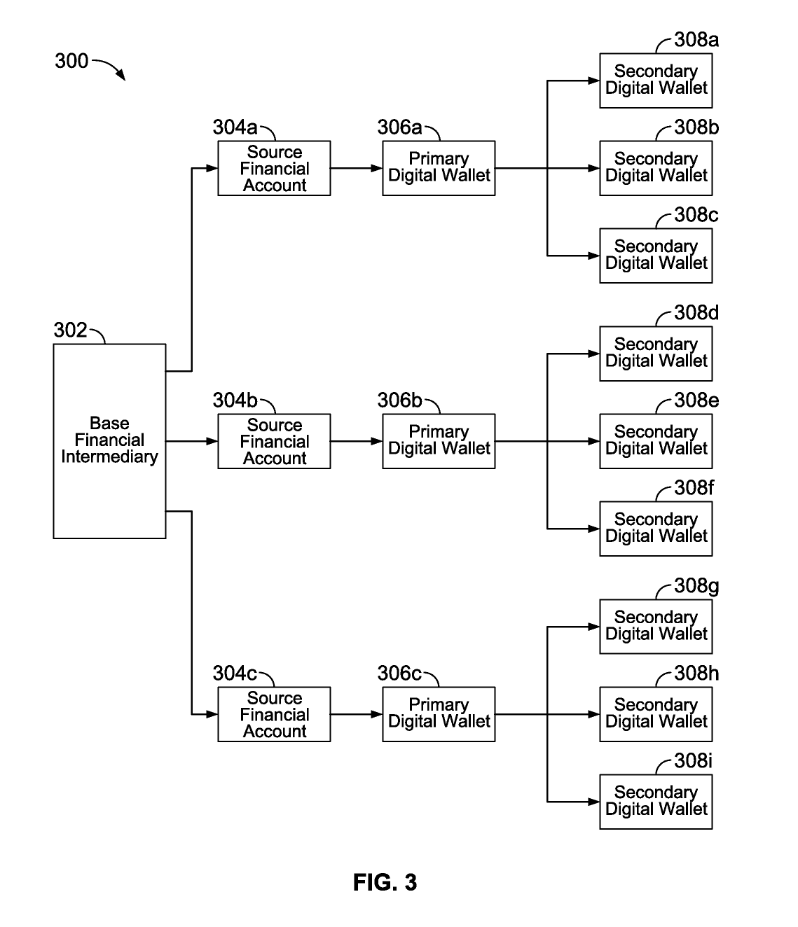

Referring to FIG. 3 is a diagram 300 illustrating association of the primary digital wallets and the secondary digital wallets with the source financial account and the base financial intermediary. The diagram 300 includes a base financial intermediary 302 holding the source financial account 304a, 304b and 304c of the respective users. The source financial accounts 304a, 304b and 304c are associated with the primary digital wallets 306a, 306b and 306c respectively. The secondary digital wallets 308a, 308b and 308c are linked with the primary digital wallet 306a, the secondary digital wallets 308d, 308e and 308f are linked with the primary digital wallet 306b and the secondary digital wallets 308g, 308h and 308i are linked with the primary digital wallet 306c.

According to anon limiting exemplary embodiment of the present disclosure, the user is allowed to top-up the primary digital wallets 306a, 306b and 306c with a required amount by transferring that amount in the source financial accounts 304a, 304b and 304c respectively. The user is enabled to use the primary digital wallets 306a, 306b and 306c as a payment option for the online and offline financial transactions. The wallet service providing platform further enables the user to create multiple secondary digital wallets 308a, 308b, 308c, 308d, 308e, 308f, 308g, 308h and 308i linked to the primary digital wallets 306a, 306b and 306c and are used by the user specified affiliates. For example, the secondary digital wallets 308a, 308b and 308c are credited with a required amount by using the balance available in the primary digital wallet 306a for enabling the user specified affiliates to use the secondary digital wallets 308a, 308b and 308c as the payment option for the online and offline financial transactions. Similarly the secondary digital wallets 308d, 308e and 308f are credited with a required amount by using the balance available in the primary digital wallet 306b. Similarly the secondary digital wallets 308g, 308h and 308i are credited with a required amount by using the balance available in the primary digital wallet 306c.

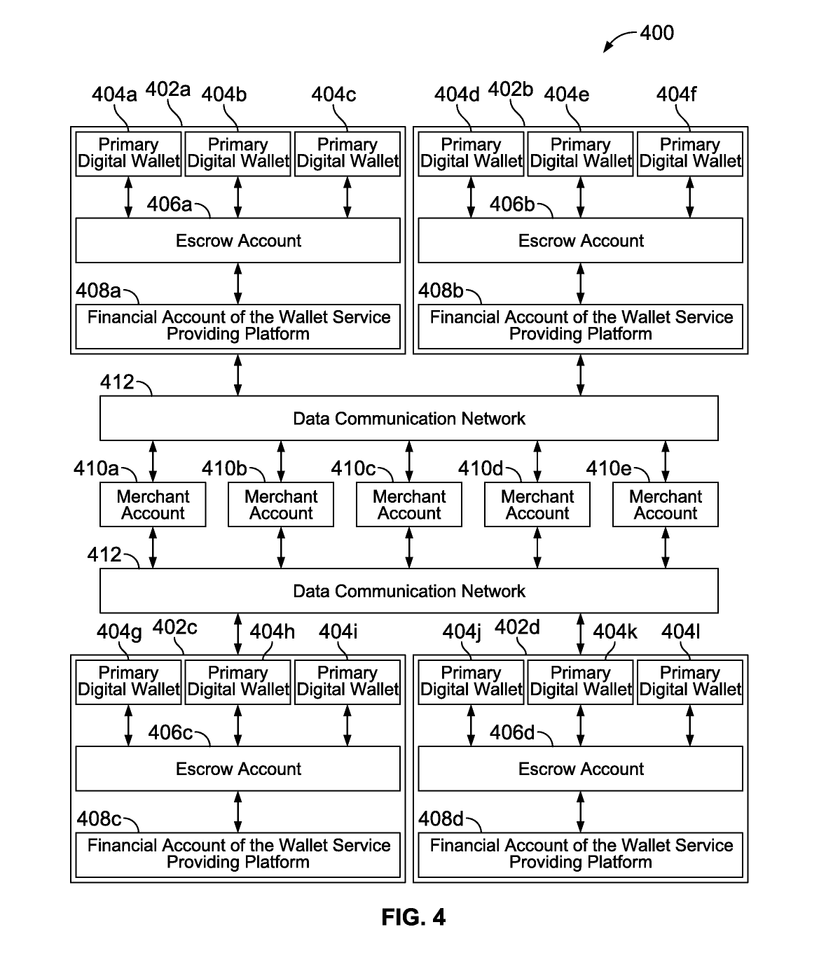

Referring to FIG. 4 is diagram 400 illustrating transaction flows between the digital wallets and the merchant accounts through the escrow account. The diagram 400 depicts base financial intermediaries 402a, 402b, 402c and 402d. The base financial intermediary 402a includes an escrow financial account 406a and a financial account of the wallet service providing platform 408a. The base financial intermediary 402b includes an escrow financial account 406b and a financial account of the wallet service providing platform 408b. The diagram 400 further depicts the base financial intermediary 402c with an escrow financial account 406c and a financial account of the wallet service providing platform 408c and the base financial intermediary 402d with an escrow financial account 406d and the financial account of the wallet service providing platform 408d. Once users makes the online and offline transactions money for the corresponding payments may be transferred from the financial account of the wallet service providing platforms 408a, 408b, 408c and 408d to the merchant accounts 410a,410b,410c and 410d.

In accordance with a non limiting exemplary embodiment of the present disclosure, for example, the total balance available in the primary digital wallets 404a, 404b and 404c and the corresponding secondary digital wallets are accumulated to the escrow financial account 406a. The total balance accumulated in the escrow financial account 406a is used for the online and offline financial transactions for the purchases made by the users within subjects to their individual wallet balances. The total amount corresponding to the purchases made by the users using the primary digital wallets 404a, 404b and 404c and the corresponding secondary digital wallets is calculated and grossed. The total gross amount is transmitted from the escrow financial account 406a to the financial account of the wallet service providing platform 408a associated with the base financial intermediary 402a. Once users makes the online and offline transactions using the digital wallets 404a, 404b, 404c, 404d, 404e, 404f, 404g, 404h, 404i, 404j, 404k, 404l money for the corresponding payments may be transferred from the financial account of the wallet service providing platforms 408a, 408b, 408c and 408d to the merchant accounts 410a,410b,410c, 410d and 410e.

According to a non limiting exemplary embodiment of the present disclosure, the financial account of the wallet service providing platform 408a associated with the base financial intermediary 402a is used to transfer the amount to the merchant accounts 410a, 410b, 410c, 410d and 410e through a data communication network 412 for the online and offline purchases made by the users. For example, if the primary digital wallet 404a and the merchant account are associated with the same base financial intermediary 402a the payment is directly made from the financial account of wallet service providing platform 408a associated with the base financial intermediary 402a. Similarly the payments corresponding to the online and offline financial transactions are made by the base financial intermediary 402a to the merchant accounts 410a, 410b, 410c, 410d and 410e through a data communication network 412. The merchant accounts may be held in the same base financial intermediary or different financial intermediary. The gross amounts from various financial accounts of wallet service providing platform or netted in terms of amount owed to merchants within a particular intermediary and settlement transfers and eventual transfer of money to merchants is conducted.

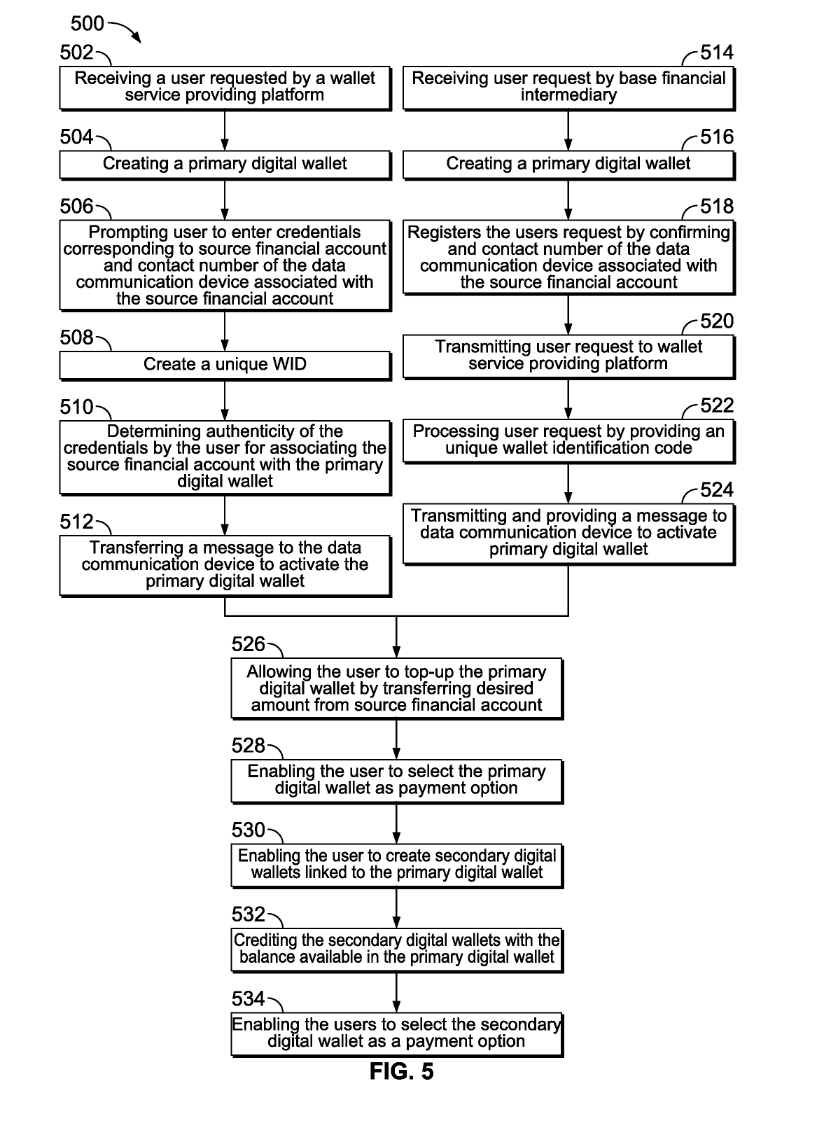

Referring to FIG. 5 is a flow diagram 500 illustrating a method for creating digital wallets which facilitates the user to perform the online and offline transactions using the digital wallets. According to a non limiting exemplary embodiment, the method starts at step 502 by receiving a request of a user by a wallet service providing platform for creating a primary digital wallet at step 504.

In accordance with a non limiting exemplary aspect of the present disclosure, at step 506 the user is prompted to enter credentials corresponding to the source financial account and the contact number of the DCD associated with the source financial account. Next at step 508 a unique wallet identification code (WID) is created and the authenticity of the credentials provided by the user for associating the source financial account with the primary digital wallet is determined at step 510. Further at step 512 a message is transmitted to the DCD of the user to activate the primary digital wallet and for successful association of the source financial account with the primary digital wallet. The method for using the created primary digital wallet for the online and offline financial transactions is continued with the step 526.

According to a non limiting exemplary aspect, the method for facilitating online and offline financial transactions may also start with the step 514 wherein a request of a user is received by a base financial intermediary for creating a primary digital wallet at step 516 and associating a source financial account with the primary digital wallet. Next at step 518 the user request s registered by confirming the contact number of the DCD of the user and the personal credentials associated with the source financial account. At step 520 the user request is transmitted to the wallet service providing platform from a base financial intermediary to create the primary digital wallet. Further at step 522 the request of the user is processed by providing a unique wallet identification code (WID) and by transmitting a message to the DCD to activate the primary digital wallet at step 524 and also for successful association of the source financial account with the created primary digital wallet. The method for using the created primary digital wallet for the online and offline financial transactions is continued with the step 526.

In accordance with a non limiting exemplary aspect of the present disclosure, at step 526 the user is allowed to top-up the primary digital wallet with a required amount by transferring that amount from the source financial account. Next at step 528 the user is enabled to select the primary digital wallet as a payment option for the online and offline financial transactions. At step 530 the user is enabled to create secondary digital wallets linked to the primary digital wallet for multiple user specified affiliates. Further at step 532 the secondary digital wallets are credited with the requested amount available in the primary digital wallet for enabling the user specified affiliates to use the secondary digital wallets as the payment option fur the online and offline financial transactions at step 534.

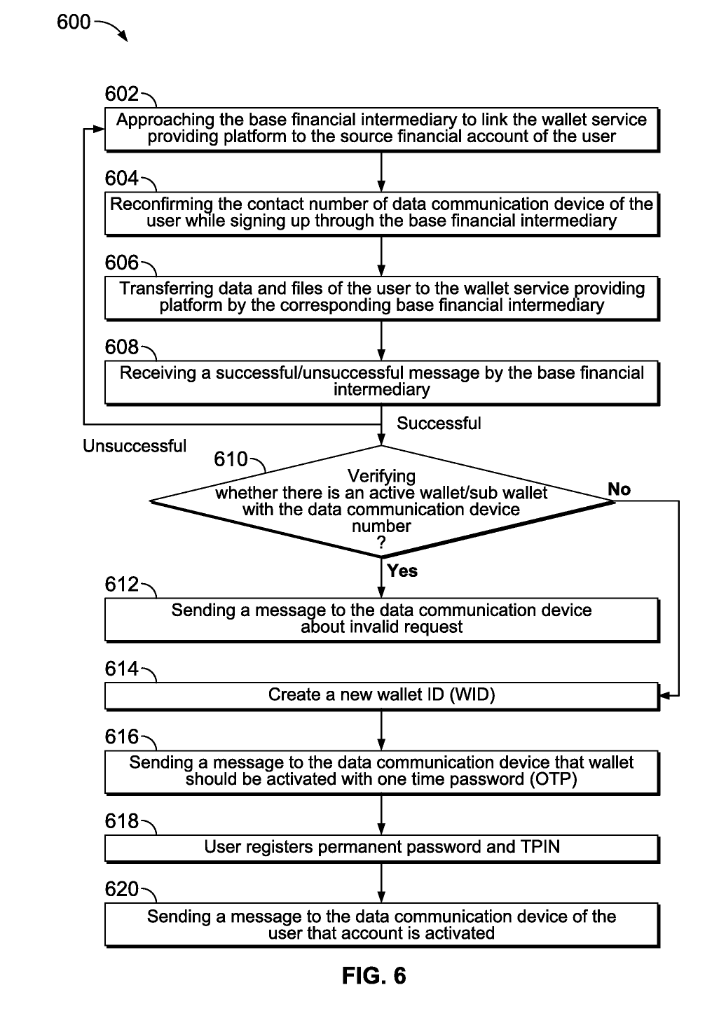

Referring to FIG. 6 is a flow diagram 600 illustrating a method for creating a primary digital wallet through a base financial intermediary. The method starts at step 602, wherein the user approaches the base financial intermediary to link primary digital wallet with the source financial account of the user.

In accordance with a non limiting exemplary aspect of the present disclosure, at step 604 the wallet service providing platform reconfirms the DCD contact number of the user while signing up through the corresponding base financial intermediary. Next at step 606 the files/credentials which may include but not limited to customer name, IFSC code, financial account number, DCD contact number, address, age and the like registered along with the source financial account of the base financial intermediary are transferred to the wallet service providing platform. Further at step 608 a successful or unsuccessful message corresponding to the registration of the primary digital wallet is received by the base financial intermediary. If the message received by the base financial intermediary conveys that the registration is successful, then the method continues with the step 610 or else the method continues with the step 602.

According to a non limiting exemplary aspect of the present disclosure, at step 610 the wallet service providing platform verifies whether there is any active primary digital wallet or secondary digital wallet with the DCD in the wallet service providing platform. If any active wallet or sub wallet is found at step 610 the method continues with the step 612 by sending a message to the contact number of the DCD of the user that previously an active primary digital wallet exists and the existing wallet should be cancelled to open a new digital wallet. If any primary digital wallet or secondary digital wallet is not found at step 610 the method continues with the step 614 by creating a new digital wallet identification code (WID). At step 616 a message is sent to the contact number of the DCD of the user stating the wallet should be activated using the onetime password (OPT). The DCD of the user receives the OTP from wallet service providing platform. Next at step 618 the user provides the onetime password and registers a permanent password and a transaction personal identification number (TPIN). Further at step 620 a message is sent to the DCD of the user confirming the primary digital wallet is activated. The advantage of bank verified details like name, age, address helps in safe Ecommerce/MCommerce transactions like physical goods can be delivered to financial intermediary registered address only, similarly age inappropriate sales can be restricted for underage users.

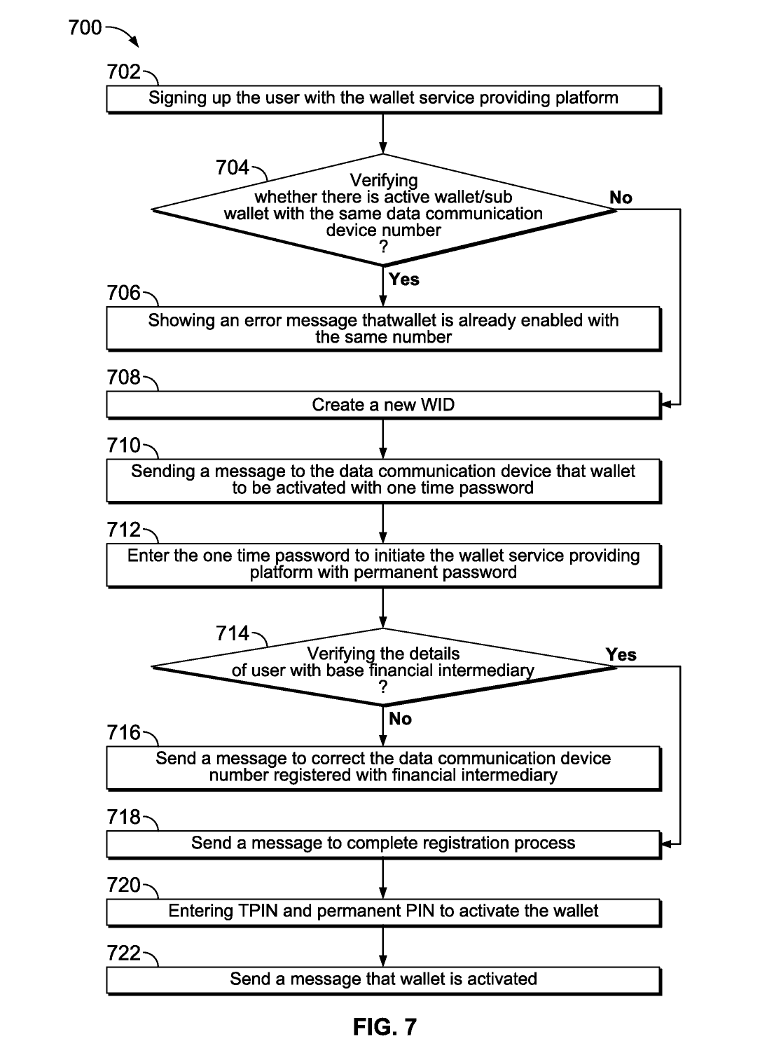

Referring to FIG. 7 is a flow diagram 700 illustrating a method for creating primary digital wallet through a wallet service providing platform. The method starts at step 702 by allowing the user to sign up and register with the wallet service providing platform by entering the details which may include but not limited to name, bank, branch, savings bank account number and the like.

According to a non limiting exemplary aspect of the present disclosure, the wallet service providing platform verifies whether there is an active primary digital wallet or secondary digital wallet with the DCD number provided by the user at step 704. If any active primary digital wallet or secondary digital wallet is found at step 704 the method continues with the step 706 by prompting an error message that a wallet is already enabled with the DCD number provide by the user. If any active primary digital wallet or secondary digital wallet is not found at step 704 the method continues with the step 708 by creating new primary digital wallet identification. At step 710 a message is sent to the DCD number of the user stating the wallet should be activated by entering the one time password. Next at step 712 the one time password is entered by the user to initiate/activate the wallet.

In accordance with a non limiting exemplary aspect of the present disclosure, at step 714 the details corresponding to the user which may include but not limited to name, branch, account number and the like are verified with the base financial intermediary. If the details verified at step 714 are found to be accurate, the other details like age, address are retrieved to the profile database of the wallet service providing platform from financial intermediary and proceeds with the step 718 by receiving a message from the wallet service providing platform to complete the registration process. Next at step 720 the permanent password and TPIN is entered to activate the wallet and a message is received by the user at step 722 confirming the wallet is activated. If the details verified at step 714 are found to be incorrect the method continues with the step 716 by sending a message to register the DCD number with the base financial intermediary or to correct the provided DCD number or to correct the account details provided to the corresponding base financial intermediary.

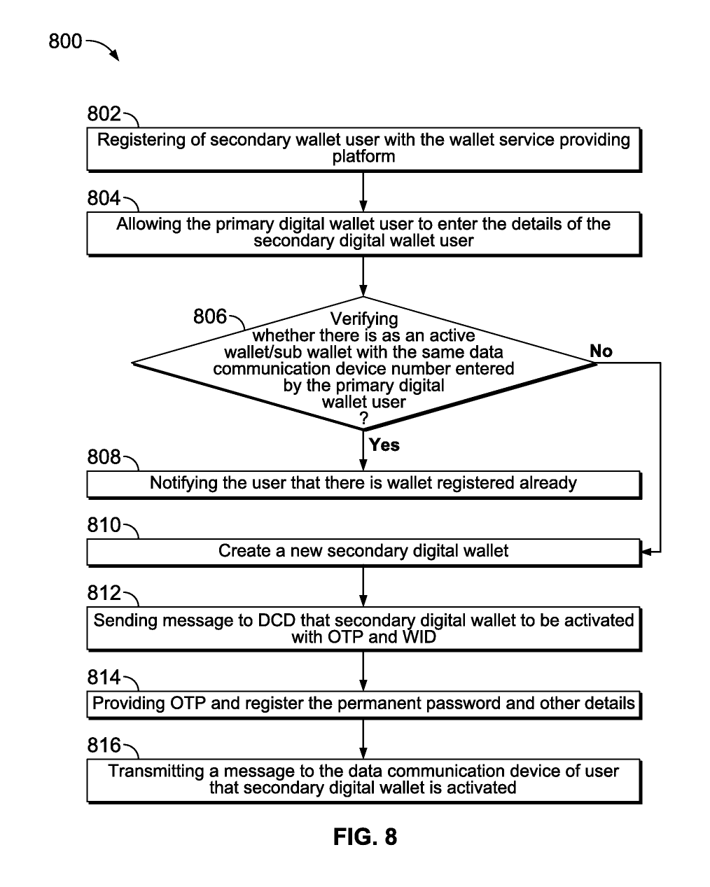

Referring to FIG. 8 is a flow diagram 800 illustrating a method of creating secondary digital wallets. The method of creating secondary digital wallets starts at step 802 by allowing the user sign up with the wallet service providing platform to create the secondary digital wallets. Next at step 804 the primary digital wallet user enters the details of the secondary digital wallet user, this method might curtail the maximum number of secondary digital wallet users or the address of the secondary digital wallet user might be enforced to be same as primary digital wallet user.

In accordance with a non limiting exemplary aspect of the present disclosure, at step 806 the wallet service providing platform verifies whether there is an active primary digital wallet or secondary digital wallet with the DCD number entered by the primary digital wallet user. If any active primary digital wallet or secondary digital wallet found at step 806 the method continues with the step 808 by sending a message to the DCD of the user that exists a primary digital wallet or secondary digital wallet which should be cancelled to open a new secondary digital wallet. If any active primary digital wallet or secondary digital wallet is not found at step 806 the method continues with the step 810 by creating new secondary digital wallet identification associated with the primary digital wallet. At step 812 a message is sent to the DCD of the user that the secondary digital wallet should be activated by providing the one time password and WID. Next at step 814, one time password is entered by the user and for registering the permanent password and a transaction PIN (TPIN) with the wallet service providing platform. Further at step 816 a message is received by the data communication device of the user that the secondary digital wallet is activated.

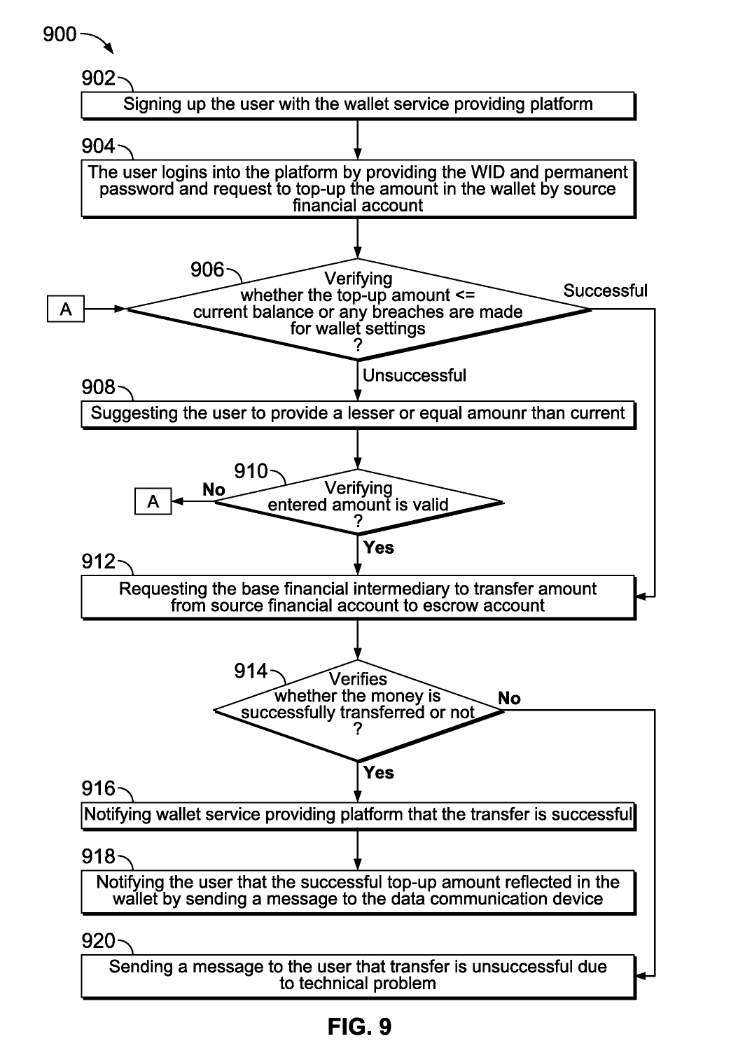

Referring to FIG. 9 is a flow diagram 900 illustrating a method to top-up the primary digital wallet. The method starts at step 902 by signing up with the wallet service providing platform. Next at step 904 the user logs in the wallet service providing platform by providing the WID and permanent password and requests to top-up the amount in the wallet using the source financial account. The user may also use a DCD number or a TPIN and other credentials associated with the digital wallet to login to the account.

In accordance with a non limiting exemplary aspect of the present disclosure, at step 906 the top-up amount is verified by the wallet service providing platform to determine whether the requested top-up amount is less than or equal to the current balance or greater than the current balance in the source financial account and any breaches are made to wallet settings. If the amount verified at step 906 is found to be greater than the current balance the method continues with the step 908 by suggesting the user to provide an amount less than the current balance. Next at step 910 the valid amount is provided by the user is verified, if the provided amount is not found to be valid due to the insufficient balance available in the source financial account or the daily transfer limits are crossed, then the method continues back with the step 906. If the provided amount is found to be valid at step 910 then the method continues with the step 912 by requesting the base financial intermediary to transfer the amount from the source financial account to the escrow account. Next at step 914 a verification is performed to determine if the transfer is successful. If the transfer is successful at the step 914 the method continues with the step 916 by notifying the wallet service providing platform that the money is successfully transferred by the base financial intermediary. If there is an unsuccessful transfer at step 914 the method continues with the step 920 by sending a message to the user that the amount is not successfully transferred due to technical problem. Further the user is also notified by the wallet service providing platform at step 918 confirming the successful top-up amount is reflected in the digital wallet and a message is sent to the data communication device of the user.

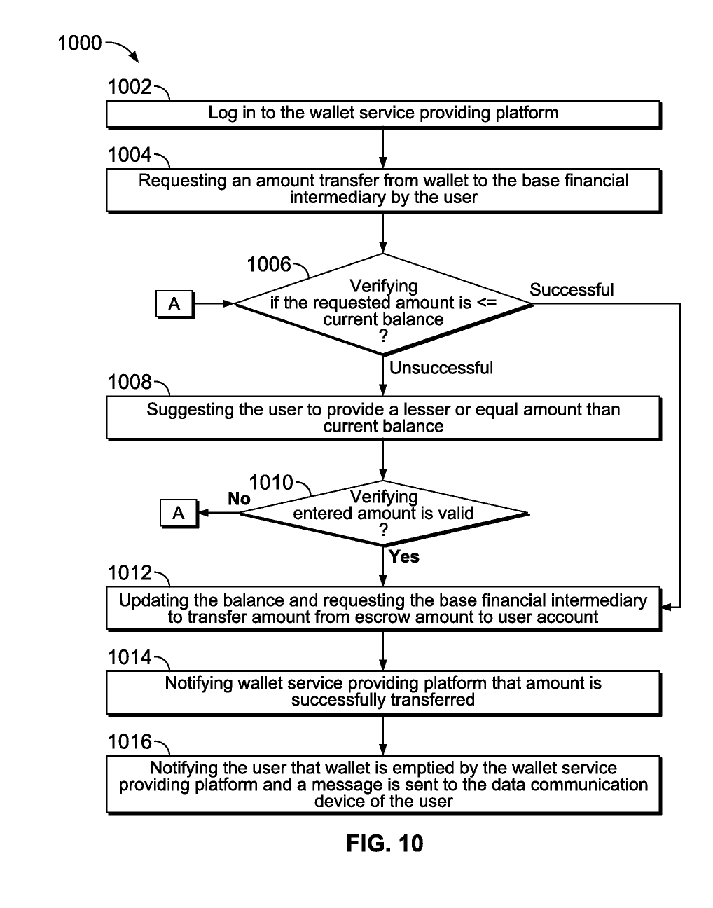

Referring to FIG. 10 is a flow diagram 1000 illustrating a method to empty the primary digital wallet. The method starts at step 1002 by logging onto the wallet service providing platform. Next at step 1004 the user requests an amount transfer from wallet to the base financial intermediary and at step 1006 a verification is done to determine whether the requested amount is less than or equal to the current balance or greater than the current balance in the wallet.

In accordance with a non limiting exemplary aspect of the present disclosure, if the requested amount is found to be greater than the current balance in the step 1006 the method continues with the step 1008 by suggesting the user to choose an amount less than or equal to the current balance. Next at step 1010 a verification is performed to determine if the amount provided by the user is valid, if the provided amount is not found to be valid the method continues with the step 1006. If the provided amount is found to be valid at step 1010 the method continues with the step 1012 by immediately updating the balance and requesting the base financial intermediary to transfer the amount from the escrow financial account to the source financial account of the user. Next at step 1014 the wallet service providing platform is notified by the base financial intermediary that the amount is successfully transmitted to the source financial account of the user and further the wallet service providing platform notifies the user that the wallet is made empty and a message is transmitted to the DCD of the user at step 1016.

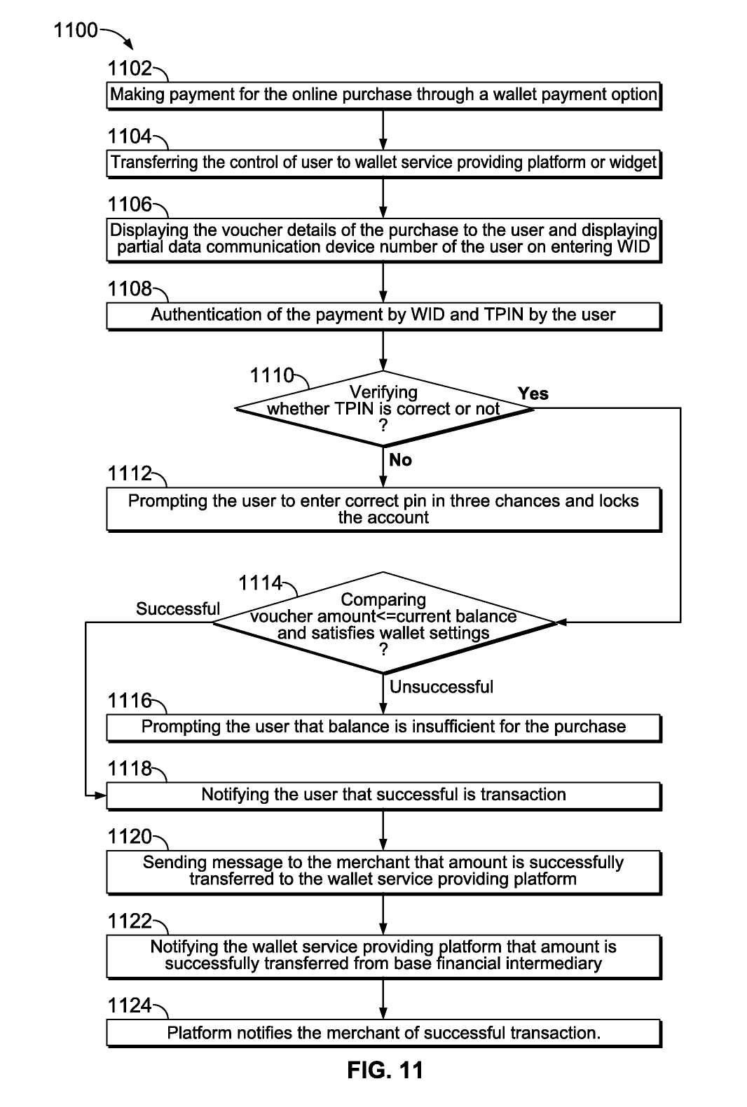

Referring to FIG. 11 is a flow diagram 1100 illustrating a method of making payments for online transactions using the primary or secondary digital wallets. The method starts at step 1102 for making payments through a wallet service providing platform for the online purchases made by the user. Next at step 1104 the control of user is transferred/the user is directed to the wallet service providing platform or to a widget integrated within merchant website or application. Here if the user chooses to pay by widget, the widget can be accessed by “Payment Button” of the platform displayed on the merchant website or application, upon selecting the payment button and entry of WID, the widget displays the partial DCD number to establish the sanctity of the payment option to the user and to protect user from online identification thefts by phishing attacks.

In accordance with a non limiting exemplary embodiment of the present disclosure, the voucher details for the purchases made by the user are displayed over the data communication device of the user by the wallet service providing platform and displays partial data communication device number on entering the WID at step 1106. Next at step 1108 the user authenticates the transaction by TPIN and WID to make the corresponding payments. At step 1110 the TPIN entered by the user is verified by the wallet service providing platform, if the TPIN entered by the user is found to be incorrect at step 1110 the method continues with the step 1112 by prompting the user to enter the correct TPIN by providing three more chances and then locks the wallet. If the TPIN entered by the user is found to be correct at step 1110 the method continues with the step 1114 by comparing the voucher amount and the current balance available in the wallet.

According to a non limiting exemplary aspect of the present disclosure, if the voucher amount is found to be greater than the current balance available in the wallet at step 1114 the method continues with the step 1116 by notifying the user that the amount is not successfully transmitted due to the unavailability of balance in the wallet. If the voucher amount is found to be less than or equal to the current balance the method continues with the step 1118 by notifying the user that the amount is successfully transmitted to the corresponding merchant account and also a message is sent to the merchant that the amount is successfully transmitted through the wallet service providing platform at step 1120. At step 1114 a validation is performed to determine if the wallet settings are satisfied and also to ensure that the wallet settings are not breached, for example breaching the threshold amount of transaction per day or transacting with a black listed merchant and the like. If the settings are breached it leads to invalid transaction and if the settings are not breached the method continues to step 1118. Further at step 1122 the wallet service providing platform is notified that the amount is successfully transmitted from the base financial intermediary and the message is sent to the user that the transaction is successfully processed at step 1124.

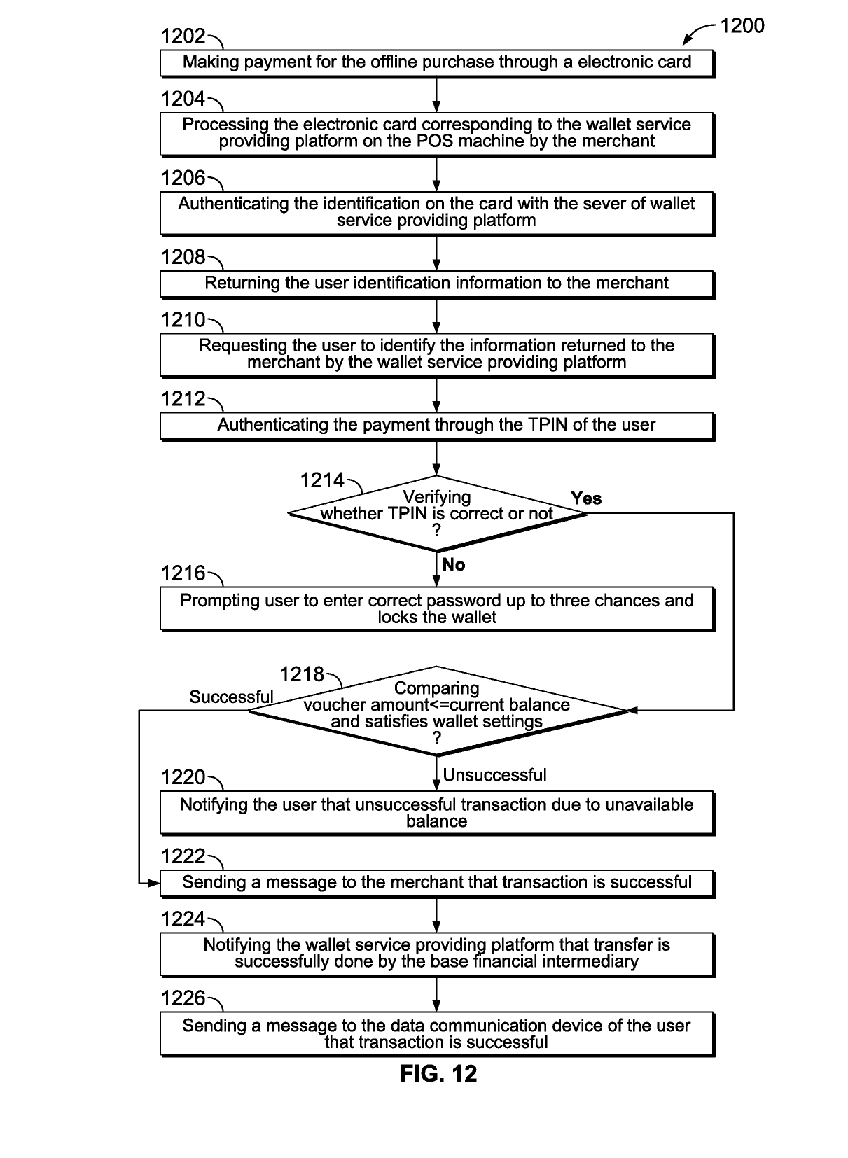

Referring to FIG. 12 is a flow diagram 1200 illustrating a method of making payments for offline transactions using the primary or secondary digital wallets. The method starts at step 1202 by making payments for the offline purchases through an electronic card associated to the primary digital wallet or the secondary digital wallet. Next at step 1204 the electronic card corresponding to the wallet service providing platform is processed over a point of sale machine or payment application (app) of the corresponding merchant which can decrypt and recognize the authentication WID of the card.

In accordance with a non limiting exemplary aspect of the present disclosure, at step 1206 the card is authenticated by the wallet service providing platform server and returns the user identification information like partial DCD number to the merchant at step 1208. Next at step 1210 the user is requested to identify the information returned to the merchant by the wallet service providing platform to establish correct credentials. Then the user authenticates the payment through the wallet identification code and the transaction PIN (TPIN) at step 1212. Next at step 1214 the TPIN entered by the user is verified by the wallet service providing platform, if the TPIN entered at step 1212 is found to be incorrect at step 1214 the method continues with the step 1216 by prompting the user to enter the correct password and provides three more chances to the user for entering the correct TPIN and then locks the wallet. If the TPIN entered is found to be correct at step 1214 the method continues with the step 1218 by comparing the voucher amount and the current balance of the wallet.

According to a non limiting exemplary embodiment of the present disclosure, if the voucher amount is found to be greater than the current balance in the step 1218, the method continues with the step 1220 by notifying the user that the transaction is not successfully processed due to the unavailability of the balance in the wallet. If the voucher amount is found to be less than or equal to the current balance in the wallet at step 1218 the method continues with the step 1222 by sending a message to the merchant that the amount is successfully transmitted. At step 1218 a validation is performed to determine if the wallet settings are satisfied and also to ensure that the wallet settings are not breached, for example breaching the threshold amount of transaction per day or transacting with a black listed merchant and the like. If the settings are breached it leads to invalid transaction and if the settings are not breached the method continues to step 1222. Next at step 1224 the wallet service providing platform is notified that the transfer is successfully processed by the corresponding base financial intermediary. Further, at step 1226 a message is transmitted to the data communication device of the user that the transaction is successfully processed.

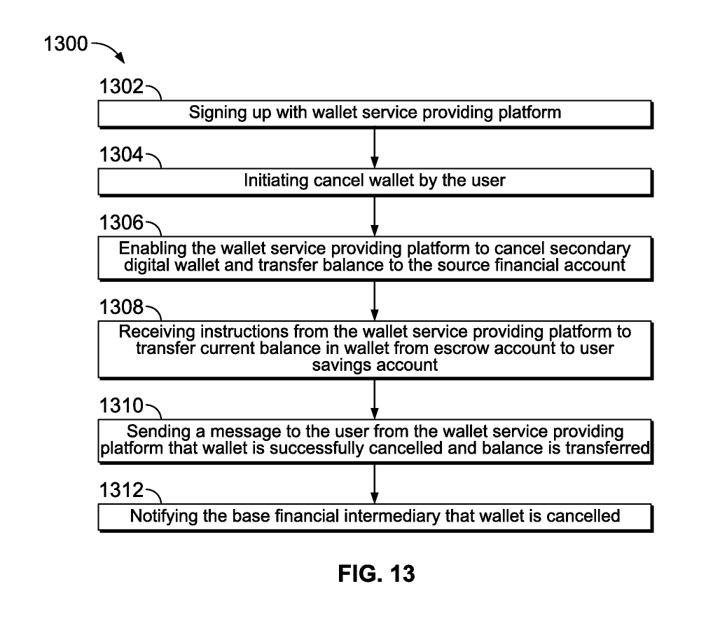

Referring to FIG. 13 is a flow diagram 1300 illustrating a method of cancelling the primary digital wallet and the secondary digital wallet. The method starts at step 1302 by allowing the user to login in to the wallet service providing platform and the user initiates to cancel the wallet at step 1304. Next at step 1306 the wallet service providing platform enables the user to cancel the secondary digital wallets corresponding to the primary digital wallet and transfer the balance amount to the source financial account.

In accordance with a non limiting exemplary aspect of the present disclosure, at step 1308 any further transactions are not allowed on the account. Next at step 1308 the wallet service providing platform sends the instructions to transfer the current balance in the wallet from escrow financial account to the savings account of the user associated with the base financial intermediary. Further at step 1310 the wallet service providing platform sends a message to the user that the wallet is successfully cancelled and the balance amount is transferred to the main account and also notifies the corresponding base financial intermediary at step 1312 that the wallet is cancelled by the user.

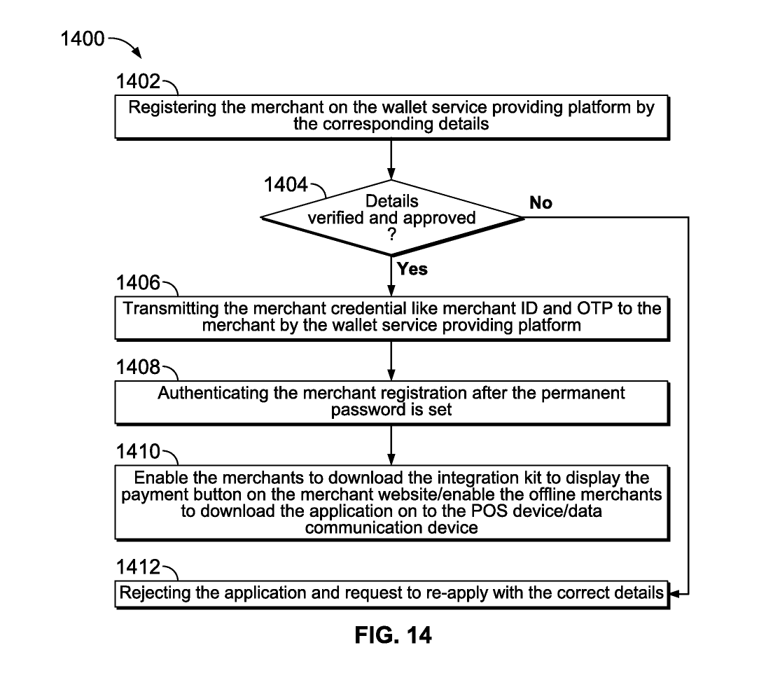

Referring to FIG. 14 is a flow diagram 1400 illustrating a method of merchant registration process. The method starts at step 1402 by allowing the merchant to upload/enter the details which may include but not limited to incorporation certificate, bank account, email id, address proof, company pan card, promoters pan card and the like.

In accordance with non limiting exemplary aspect of the present disclosure, the personnel of wallet service providing platform manually verifies the details provided by the merchant at step 1404. If the verified details are found to be genuine at step 1404 the method continues with the step 1406 by transferring the details of merchant identification code (merchant ID) and one time password to the merchant. Finally at step 1408 merchant is authenticated once the permanent password is set by the merchant. Next at step 1410 the electronic merchants can download an integration kit. The integration of this kit will enable a payment button to be displayed on the digital kart on the website of the merchant. The application/kit is capable of transmitting an encrypted merchant ID along with the user credentials. Once the user selects the payment button after entering Wallet ID, a partial number of DCD is displayed to fulfil the online transaction. Similarly, for the offline merchants the payment application can be installed either in the DCD of the merchant or POS terminal of the merchant to recognize the electronic card as well as to enable fulfilment of the offline payment. If the verified details are found to be incorrect at step 1404 the method continues to step 1412 by rejecting the application and request to re-apply with the correct details.

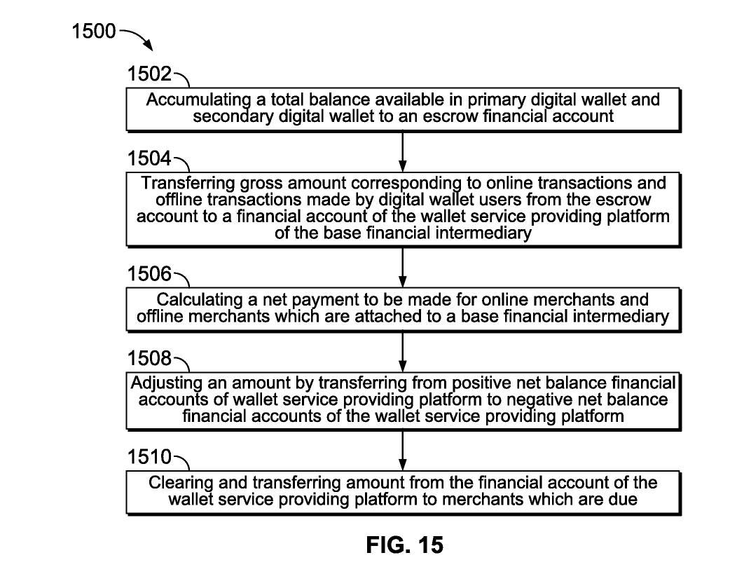

Referring to FIG. 15 is a flow diagram 1500 illustrating a method of netting and clearance corresponding to online and offline transactions. The method starts at step 1502 by accumulating the total balance available in the primary digital wallets and the secondary digital wallets to an escrow financial account for the online and offline purchases made by the user. Next at step 1504 the gross amount corresponding to the online and offline financial transactions made by the user by using the primary digital wallets and the secondary digital wallets are transferred from the escrow financial account to the financial account of the wallet service providing platform with the base financial intermediary. Further at step 1506 a net payment to be made for the online and offline merchants corresponding to a particular financial intermediary is calculated. The net payment is calculated by amount in the financial account of wallet service providing platform is less than the total amount to be paid to merchants attached to that same financial intermediary. The net balances that should be available in each account are calculated. This gives the net amount to be transferred either in or out from each of the financial accounts of the wallet service providing platform. The settlement instructions will be sent to each financial intermediary to transfer the net amounts. Finally at step 1508, adjusting an amount by transferring from positive net balance financial accounts of wallet service providing platform to negative net balance financial accounts of the wallet service providing platform is performed. Finally, at step 1510 amount from the financial account of the wallet service providing platform to merchant accounts which are due is cleared. The balances of the merchant accounts are updated by wallet platform to be available for withdraw from there linked financial accounts.

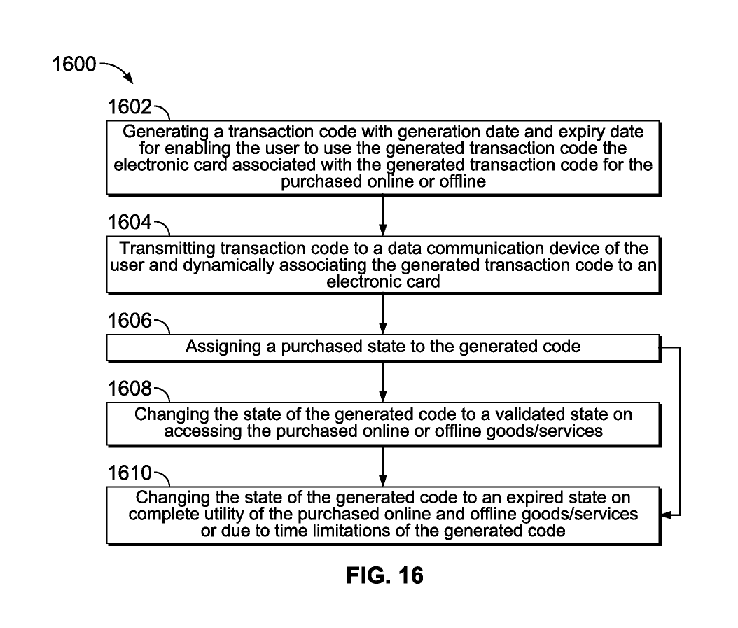

Referring to FIG. 16 is a flow diagram 1600 illustrating a method of tracking transaction properties of transactions made using the digital wallet platform. The method starts at step 1602 by generating a transaction code with a generation date and an expiry date for enabling the user to use the generated transaction code and the electronic card associated with the generated transaction code for the purchased online and offline services. Next at step 1604, the transaction code is transmitted to a data communication device of the user and the generated transaction code is dynamically associated to the electronic card of the user. At step 1606, the status of the generated code is assigned with purchased state. Next at step 1608 the state of the generated code is changed to a validated state on accessing the purchased online or offline goods/services and at step 1610 the state of the generated code is changed to an expired state on complete utility of the purchased online and offline goods/services or due to time limitations of the generated transaction code.

In accordance with non limiting exemplary aspect of the present invention, the wallet service providing platform has the capability to not only enable payments for exchange of good or services but can also act as a gatekeeper track and response system for the various transaction states during the lifecycle of a transaction. The transaction ID that is generated will be transferred either to the DCD of the user or the transaction ID will he digitally imprinted or associated to the card in case of offline transactions. The wallet service providing platform tracks, online or offline, the transaction state and returns either go or “no go” upon enquiry by the widget for online transactions or card readable machines in case of offline or POS transactions. For example a voucher may also be generated for usage by the user. The voucher can be enforced to be utilized by authorized wallet users for their use only, as well as it expires by other parameters like time and place of access. The utility of these functions is multifold but not limited to encrypted media files which can be accessed by proprietary media players which are tied with the wallet service providing platform and can enforce pay per view access of the media files. Also in case of mass transport ticketing solutions like metro trains and bus transport the electronic card itself can act as a voucher for access to the service.

While specific embodiments of the disclosure have been shown and described in detail to illustrate the inventive principles, it will be understood that the disclosure may be embodied otherwise without departing from such principles.

What is claimed is:

1. A computer implemented method for facilitating online and offline financial transactions over a network, the method comprising:
receiving a request of a user by a wallet service providing platform for creating a primary digital wallet, whereby the user prompted by an interface to enter one or more credentials corresponding to a source financial account and a contact number of a data communication device associated with the source financial account to create an unique wallet identification code;
determining the authenticity of the one or more credentials provided by the user for associating the financial account of the user with the primary digital wallet, whereby the wallet service providing platform transmits a message to the data communication device to activate the primary digital wallet and for successful association of the base financial account;
allowing the user to top-up the primary digital wallet with a predetermined amount by transferring an amount available in the source financial account, whereby the user enabled to select the primary digital wallet as a payment option for one or more online and offline financial transactions; and
enabling the user to create one or more secondary digital wallets linked to the primary digital wallet for a plurality of user specified affiliates, where by the one or more secondary digital wallets credited with a predetermined amount using an amount available in the primary digital wallet for enabling the one or more user specified affiliates to use the one or more secondary digital wallets as the payment option for the one or more online and offline financial transactions.

2. The method of claim 1 comprising a step of providing transaction personal identification number for authenticating the one or more online transactions using the primary digital wallet and the one or more secondary digital wallets.

3. The method of claim 1 comprising a step of displaying a partial contact number of the data communication device of the user and one or more personal credentials associated with the primary digital wallet and the one or secondary digital wallets while making a payment for the one or more online and online transactions.

4. The method of claim 1 comprising a step of enabling the user to define a transaction limit for the one or more primary digital wallets and one or more secondary digital wallets.

5. The method of claim 1 comprising a step of enabling the use to transfer an amount from the one or more secondary digital wallets to the primary digital wallet.

6. Then method of claim 1, comprising a step of: enabling the user of the primary digital wallet to restrict the usage of the primary digital wallet and the one or more secondary digital wallets; and enabling the secondary digital wallet user to restrict the usage of the secondary digital wallet.

7. The method of claim 1 comprising a step of enabling the user to restrict the usage of the primary digital wallet and the one or more secondary digital wallets for one or more unauthorized online and offline transactions.

8. Then method of claim 1 comprising a step of directing the user to the wallet service providing platform for making payment to the one or more online transactions.

9. The method of claim 1 further comprising a step of enabling a plurality of merchants to register with the digital wallet service providing platform.

10. The method of claim 9, wherein the step of registering the merchants with digital wallet service providing platform further comprising a step of providing a unique merchant account.

11. The method of claim 1 comprising a step of enabling the user to associate an electronic card provided by the wallet service providing platform to the primary digital wallet and the one or more secondary digital wallets.

12. The method of claim 1 comprising the step of enabling the user to use the electronic card for the offline financial transactions.

13. The method of claim 1 further comprising a step of enabling the user to dissociate the primary digital wallet with the source financial account.

14. The method of claim 1 further comprising a step of enabling the user to transfer the amount available in the primary digital wallet to the source financial account.

15. The method of claim 1 further comprising a step of deactivating the one or more secondary digital wallets.

16. The method of claim 1, wherein the payments made by the user using the primary digital wallets for one or more online and offline financial accounts transferred from the primary digital wallet to a financial account of the merchant and payments made by the user using the one or more secondary digital wallets for one or more online and offline financial accounts transferred from the one or more secondary digital wallets to a financial account of the merchant.

17. The method of claim 1 comprising a step of enabling the user to perform the offline transactions by entering at least one of: a transaction personal identification number; and a wallet identification code in a merchant terminal.

18. The method of claim 1 comprising a step of enabling the user to use the primary digital wallet and the one or more secondary digital wallets without entering the transaction personal identification number in the merchant terminal for a predetermined number of transactions and amount per transaction.

19. A computer implemented method for facilitating online and offline financial transactions, the method comprising:
receiving a request of a user by a base financial intermediary platform for creating a primary digital wallet and associating a source financial account with the primary digital wallet, whereby the base financial intermediary platform registers the user request by confirming a contact number of a data communication device of the user and one or more personal credentials associated with the source financial account;
transmitting the user request to a wallet service providing platform from the base financial intermediary platform to create the primary digital wallet, whereby the wallet service providing platform processes the user request by providing an unique wallet identification code and transmits a message to the data communication device to activate the primary digital wallet and for successful association of the source financial account with the created primary digital wallet;
allowing the user to top-up the primary digital wallet with a predetermined amount by transferring an amount available in the source financial account, whereby the user enabled to select the primary digital wallet as a payment option for one or more online and offline financial transactions; and
enabling the user to create one or more secondary digital wallets linked to the primary digital wallet for a plurality of user specified affiliates, where by the one or more secondary digital wallets credited with a predetermined amount using an amount available in the primary digital wallet for enabling the one or more user specified affiliates to use the one or more secondary digital wallets as the payment option for the one or more online and offline financial transactions.

20. The method of claim 19 further comprising a step of enabling the user to credit the one or more secondary digital wallets using an amount available in the primary digital wallet.

21. The method of claim 19 further comprising a step of displaying a merchant details and a plurality of credentials corresponding to a purchased product while making the payment using the primary digital wallets and the one or more secondary digital wallets.

22. The method of claim 19 further comprising a step of defining a restriction on a number and total amount of transactions on online transactions and offline transactions using the primary digital wallet and the one or more secondary digital wallets.

23. The method of claim 19 further comprising a step of defining a total number and amount per transaction on offline transactions to be performed using a transaction personal identification number of the primary digital wallets and the one or more secondary digital wallets.

24. The method of claim 19 further comprising a step of defining a total number amount per transaction of offline transactions to be performed without using the transaction personal identification number of the primary digital wallets and the one or more secondary digital wallets.

25. A method for providing online and offline financial transactions using wallet service platform:
accumulating a total balance available in a plurality of primary digital wallets and a plurality of secondary digital wallets to an escrow financial account associated with a base financial intermediary;
transferring a gross amount corresponding to one or more online transactions and one or more offline transactions made by a plurality of digital wallet, users from the escrow account to a financial account of the wallet service providing platform of the base financial intermediary;
calculating a net payment to be made for one or more online merchants and one or more offline merchants attached to a base financial intermediary;
adjusting an amount by transferring from positive net balance financial accounts of wallet service providing platform to negative net balance financial accounts of the wallet service providing platform; and
clearing and transferring amount from the financial account of the wallet service providing platform to one or more online merchant accounts and one or more offline merchant accounts, which are due;

26. A networked system for providing online and offline financial transactions, the system comprising:
a wallet service providing platform for enabling the user to select as a payment option and make payments for one or more online and offline financial transactions, the wallet service providing platform, further comprising:
a transaction database for managing and storing a payment and purchase history of a primary digital wallet and one or more secondary digital wallets; and
a controller and profile management database configured to maintain profile of one or more users holding a primary digital wallet and control the usage of the primary wallet and one or more secondary digital wallets associated with an unique identification code of the primary digital wallet;
one or more base financial intermediary platforms for receiving a user request from the wallet service providing platform and transmitting the user request to wallet service providing platform for associating a financial account of the user to the primary digital wallet and also allow the user to perform multiple financial transactions from the base financial account to the primary digital wallet and to the one or more secondary digital wallets, whereby the user enabled to transfer a balance available in the base financial account to the primary digital wallet and to the one or more secondary digital wallets for making online payments and offline payments;
one or more merchant terminals operated in a data communication network and in communication with the wallet service providing platform configured to read an electronic card associated to: the primary digital wallet; and one or more secondary digital for receiving offline payments, whereby the user is enabled to select the wallet service providing platform for making offline payments using the primary digital wallet and the one or more secondary digital wallets.

27. The system of claim 26 further comprising a server unit for routing a data communication between the wallet service providing platform, one or more base financial intermediary platforms and one or more electronic merchant terminals.

28. The system of claim 26, wherein the user enabled to access the wallet service providing platform through a data communication device operated in a secured data communication network.

29. The system of claim 26, wherein the wallet service providing platform accessible as a web based application and as a mobile based application.

30. The system of claim 26, wherein the merchant terminal comprising: a point of sale terminal; and a data communication device.

31. The system of claim 30, wherein the merchant terminal configured to read an electronic card associated with the primary digital wallet and the one or more secondary digital wallets for receiving the payment from the user.

32. The system of claim 26, wherein the merchant terminal configured with an application to access the wallet service providing platform.

33. The system of claim 26, wherein the merchant terminal configured to display the partial contact number of the user associated with the primary digital wallet and the one or more secondary digital wallet.

34. The system of claim 26, wherein the wallet service providing platform enabled to store and track transaction properties of the primary digital wallet and the one or more secondary digital wallets.

35. A method for tracking transaction properties of digital wallets, using a wallet service providing platform, the method comprising:
generating a transaction code with a generation date and an expiry date for enabling the user to use the generated transaction code and a electronic card associated with the generated transaction code for accessing the purchased online goods/services or the purchased offline goods/services;
transmitting a transaction code to a data communication device of the user and dynamically associating the generated transaction code to the electronic card of the user; and
assigning a purchased state to the generated code, whereby the state of the generated code is changed to a validated state on accessing the purchased online goods/services or the purchased offline goods/services and to a expired state on complete utility of the purchased online goods/services or the purchased offline goods/services and due to time limitations of the generated code.

36. The method of claim 35 further comprising a step of storing the generated transaction code in the transaction database.

37. The method of claim 35 further comprising a step of enabling the user to use the electronic card associated with the generated transaction code for the offline transactions.

38. The method of claim 35 further comprising a step of returning the current state of transaction on providing a transaction code to the platform by an online device; and offline device.

39. The method of claim 35 further comprising a step of enabling the user to use the electronic card associated with the generated transaction code for the offline transactions without using a transaction personal identification code.
